(19) United States
(12) Patent Application Publication
(10) Pub. No.: US 2013/0110646 A1
(43) Pub. Date: May 2, 2013

(54) INTERNET BASED SYSTEM FOR MANAGING A NETWORK OF ELECTRONIC ADVERTISING BILLBOARDS THROUGH A WIRELESS TELECOMMUNICATIONS SYSTEM

(71) Applicant: Jeff Meyers, Scottsdale, AZ (US)

(72) Inventors: Tyson York WINARSKI, Tempe, AZ (US); Jeff MYERS, Phoenix, AZ (US)

(73) Assignee: Jeff Meyers, Scottsdale, AZ (US)

(21) Appl. No.: 13/712,565

(22) Filed: Dec. 12, 2012

Related U.S. Application Data
(63) Continuation of application No. 13/213,770, filed on Aug. 19, 2011, now abandoned.
Application No. 13/213,770 is a continuation of application No. 09/662,968, filed on Sep. 15, 2000, now abandoned.

(51) Int. Cl. G06Q 30/02

(52) U.S. Cl. CPC G06Q 30/0276
USPC 705/14.72

(57) ABSTRACT

A computer system manages a network of electronic advertising billboards through a wireless telecommunications system. The electronic billboard management system is comprised of a web-site supported by a global computer network. This web-site communicates with the network of electronic billboards via wireless telecommunications.

Once the purchaser has logged in to the website, he or she has access to the Purchase Advertising System, Upload Advertising System, the Account Support System, and the Advertising Design System. Using the Purchase Advertising System, a purchaser can select the number of electronic billboards, the geographic areas, and the times in which he or she wishes to advertise. The Advertising Design System is a graphics art computer program that can create a variety of still or animated images. Once a purchaser has created an advertisement, he will then access the Upload Advertising System to place his or her advertisements into action.

### FIELD OF THE INVENTION

The present invention generally relates to the field of management systems supported by a global computer network. More specifically, the present invention relates to a computer system that manages a network of electronic advertising billboards through a wireless telecommunications system.

### BACKGROUND

Technology is having a massive impact upon our economy. The global computer network known as the World Wide Web has facilitated a business revolution and propelled the world into an Information Age. All sectors of the economy are seeking to improve their efficiency and productivity by incorporating the benefits brought by advancing technology.

The billboard advertising industry is one sector of the economy that could greatly benefit from the benefits of advancing technology and the World Wide Web. At present, the most dominant technology used for billboard advertising is the well-known highway and street side billboard. These billboards are comprised of a metal or wooden frame that supports a large image advertising a business, product, event, political message, or team sport. However, with then invention of large flat screen displays, billboard advertising has moved into the electronics age. Through the use of large flat screen displays such as the Jumbotron produced by the Sony Corporation, the billboard advertising industry can now project a commercial to viewers instead of a mere still image. In addition to these large flat screen television displays, various other large electronic displays that can project clear advertising images are now currently in use.

At present, the use of these large flat screen displays is not very common. Heavily traveled locations in the largest of cities like New York's Times Square have large flat screen displays. Several professional sports facilities have large flat screen displays such as Bank One Ballpark, home of the Arizona Diamondbacks. These large flat screen displays are used for advertising.

With the advance of technology and manufacturing capacity, it is anticipated that these large flat screen displays with increase in number. In fact, with time, large flat screen displays may replace the printed still image billboards now seen by the highway and in the cities. This future network of electronic billboard displays will require a computer-based network to manage them.

### SUMMARY OF THE INVENTION

The object of the present invention is a computer-based system that manages a network of electronic billboards through a wireless telecommunications system. This electronic billboard management system is comprised of a web-site supported by a global computer network. This web-site communicates with the network of electronic billboards through a variety of methods. The primary method of communication is a wireless telecommunications link. The web-site accesses a communications server that dials out to a communications antenna or satellite link. This antenna or satellite then transmits information from the web-site to the wireless receiver connected to the electronic billboard. Alternatively, billboards may include a direct telephone line for communication with the web-site.

To buy advertising space on this network of electronic billboards, a purchaser will access the web-site supported by the global computer network via an Internet service provider (ISP). Once the purchaser has accessed the web-site, the purchaser will first encounter the web-site login system. If the purchaser is a first time purchaser, he will have to go through a registration system. The purchaser will have to provide their personal name, company name, billing address, e-mail address contact information, and other general information. Once the purchaser has registered, the web-site registrations system will provide him with a login name and password. If the purchaser has already registered, they will simply provide their login name and password to the login system.

Once the purchaser has logged in, he or she has access to the Purchase Advertising System, Upload Advertising System, the Account Support System, and the Advertising Design System. To buy advertising on one or more of the electronic billboards, the purchaser will access the Purchase Advertising System. The Purchase Advertising System includes a series of maps that show the locations of the electronic billboards throughout the nation and the world. These maps are layered in order of detail. The first level map shows the entire world. A purchaser will then select a country in which they wish to advertise. From there the purchaser can select state, county, and city maps to determine the location of available billboards. In addition, these maps include the ability to access a digital image of the actual billboard and its surrounding vicinity.

A purchaser would now access the availability screen. This availability screen lists the locations and times of electronic billboard space that is still available for purchase.

To actually buy advertising space on these electronic billboards, a purchaser will access a purchase advertising order form within the Purchase Advertising System. On this order form, a purchaser can select the number of electronic billboards and the geographic area in which he wishes to advertise. In addition, the purchaser can select the time at which he wishes to advertise. For instance, a purchase could buy space on all of the electronic billboards in an entire city for five minutes at the same time. The web-site will determine the cost for renting the space requested by the purchaser. The purchaser would then enter credit card information to pay for the rented advertising space. Once the purchaser has paid for the rented space, the web-site will give him an access code to for use with the Upload Advertising System to upload the actual advertisement to the computer system.

A purchaser can create an advertisement through two methods. He or she can either create an advertisement using his or her own resources. Or, he or she can access the Advertising Design System. The Advertising Design System is a graphics art computer program that can create a variety of still or animated images. A purchaser who lacks the software to create their own advertising can thereby use the software supported by the web-site to create and advertisement.

Once a purchaser has created an advertisement, he will then access the Upload Advertising System. The purchaser will provide the Upload Advertising System with the code created by the Purchase Advertising System. This code enables the Upload Advertising System to access the purchaser's account and determine which billboards are to carry the advertisement at what times. The Upload Advertising System then accesses a communications server that dials out to a communications antenna or satellite link. This antenna or satellite then transmits digital advertisement from the web-site to the wireless receiver connected to the electronic billboard. Alternatively, billboards may include a direct telephone line for communication with the web-site.

The primary object of the invention is to create a computer supported method and system that can manage a plurality of electronic billboards. A further object of the invention is to produce a system whereby purchasers of billboard advertising can buy advertising space on electronic billboards via the Internet. A still further object of the invention is to enable the Internet based billboard management system to communicate with the network of electronic billboards through a wireless communications system.

In one embodiment, the invention is implemented to provide a method for operating a computer supported method and system that can manage a plurality of electronic billboards. In another embodiment, the invention is implemented to provide an apparatus for operating a computer supported method and system that can manage a plurality of electronic billboards. In still another embodiment, the invention is implemented to provide a signal-bearing medium tangibly embodying a program of machine-readable instructions executable by a data processing apparatus for operating a computer supported method and system that can manage a plurality of electronic billboards. Finally, another embodiment consists of logic circuitry having a plurality of interconnected, electrically or optically conductive elements configured for operating a computer supported method and system that can manage a plurality of electronic billboards.

Further objects and advantages of the invention will become apparent as the following description proceeds and the features of novelty which characterize this invention are pointed out with particularity in the claims annexed to and forming a part of this specification.

### BRIEF DESCRIPTION OF THE DRAWINGS

The novel features that are considered characteristic of the invention are set forth with particularity in the appended claims. The invention itself; however, both as to its structure and operation together with the additional objects and advantages thereof are best understood through the following description of the preferred embodiment of the present invention when read in conjunction with the accompanying drawings wherein:

FIG. 1 shows a diagram of the overall system for managing a network of electronic billboards;

FIG. 2 shows a diagram of the wireless system of a single electronic billboard;

FIG. 3 shows a block diagram of the systems comprising the management system supported by a web-site on a global computer network;

FIG. 4 shows the process of logging in and registering as a user;

FIG. 5 shows the process for searching for available advertising space;

FIG. 6 shows the process for buying an advertisement;

FIG. 7 shows the process for creating an advertisement;

FIG. 8 shows the process for uploading an advertisement and distributing it to the network of electronic billboards;

FIG. 9 shows a user/registration database;

FIG. 10 shows an electronic billboard database;

FIG. 11 shows an information bearing cartridge;

FIG. 12 shows an information bearing storage medium for the microcode used in processing the activity of the electronic billboard management system; and

FIG. 13 shows an information bearing semiconductor chip.

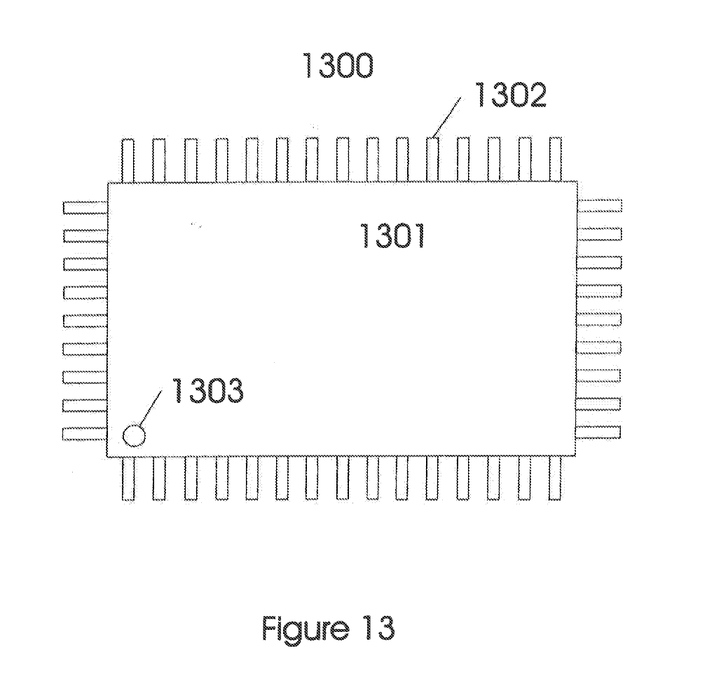

### DESCRIPTION OF THE PREFERRED EMBODIMENTS

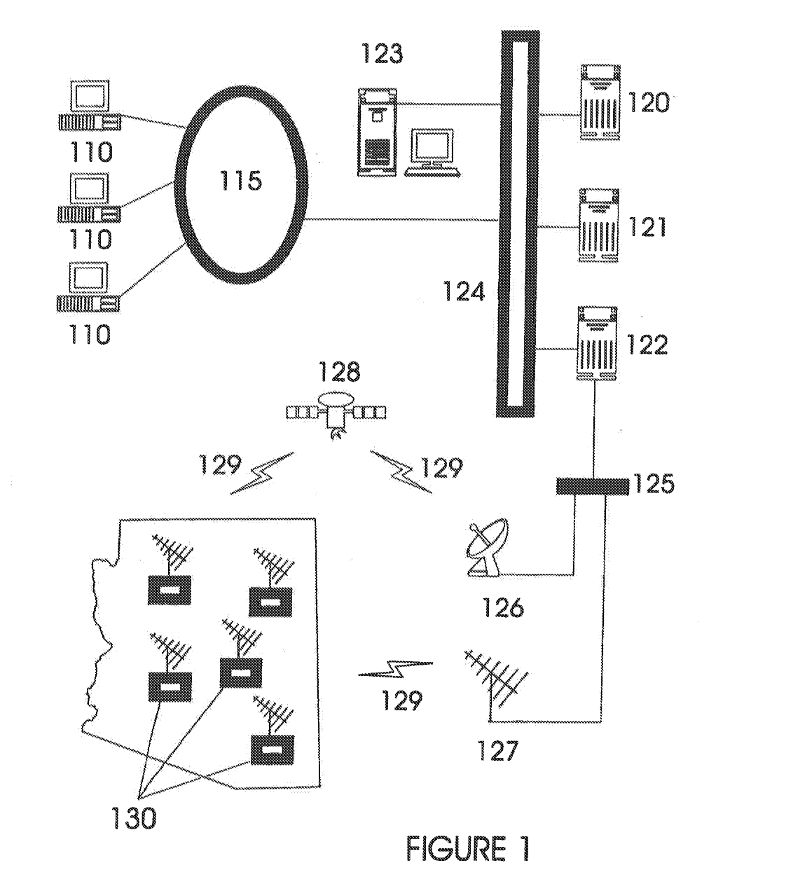

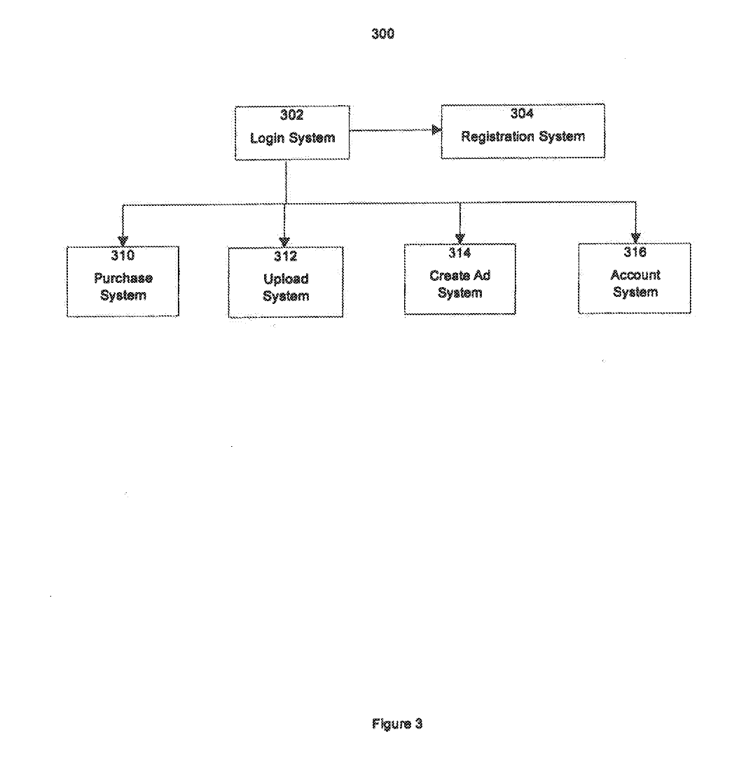

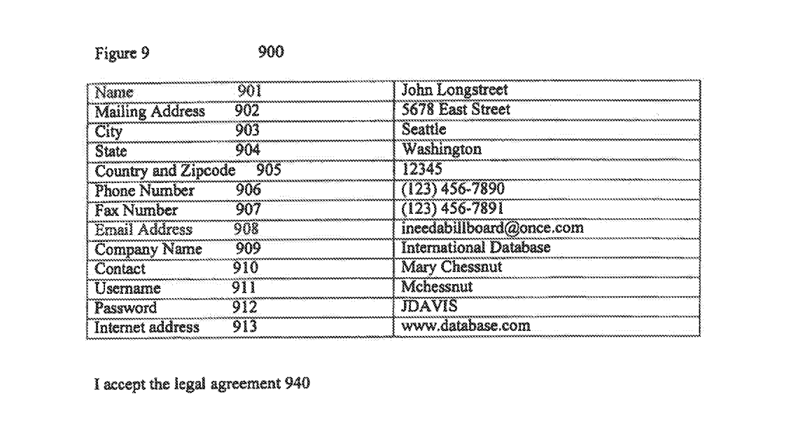

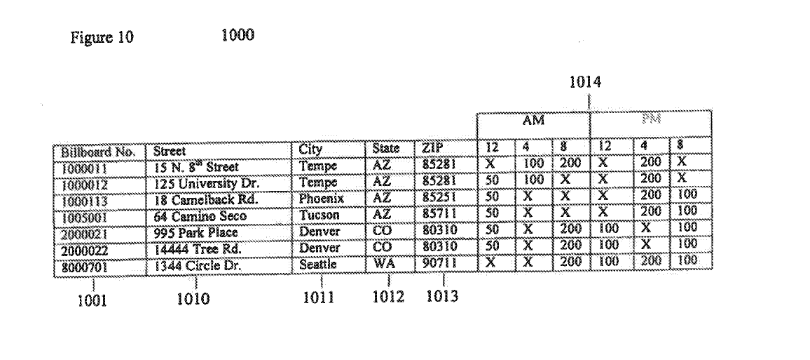

A diagram of the overall system for managing a network of electronic billboards is shown in FIG. 1. A plurality of personal home computers 110 are connected to a global computer network 115 such as an Internet. This global computer network 115 is connected to a local Ethernet 124. The Ethernet 124 is managed by a system administration computer 123. A database server 120, a web server 121, and a communications server 122 are connected to the Ethernet 124. The database server 120 stores the user/registration database 900 shown in FIG. 9. The database server 120 also stores the billboard database 10000 shown in FIG. 10. The web server 121 supports the web site 300, shown in FIG. 3, that is accessible from the global computer network 115.

The communications server 122 connects the Ethernet 124 to a satellite dish 126 or a radio antenna 127 through a communications system 125 in order to wirelessly communicate with one or more electronic billboard systems 130 located within a geographic region such as the State of Arizona. In the event a satellite dish 126 is used, data bearing signals 129 are transmitted from the satellite dish 126 to a satellite 128 and relayed to one or more of the electronic billboard systems 130. The communications server 122 can also elect to transmit data bearing signals 129 through a radio tower 127 to one or more of the electronic billboard systems 130. The signals 129 can be either analog or digital signals.

In order to access the web site 300, a user will first log on to one of the personal computers 110. The user will then access the global computer network 115 from her personal computer 110. Once the user has accesses the global computer network 115, the user will direct her computer to access the web site 300 supported by the web server 121. Once the user is in communication with the web site 300 whose architecture is shown by the chart 300, the user can conduct electronic billboard commerce.

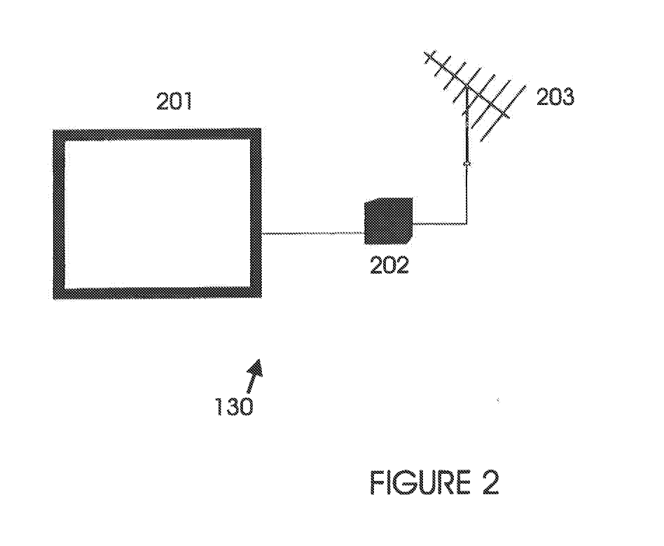

FIG. 2 shows a diagram of the wireless system of a single electronic billboard. Visual output of the advertisement is seen on display 201. Display 201 could preferably be a gas-discharge display, which is commonly known as a plasma display. A gas-discharge display contains neon between a horizontal and vertical set of electrodes. When a vertical and a horizontal electrode are charged, the neon glows at their intersection, emitting light. Display 201 may equally be a cathode ray tube (CRT) commonly used with desktop computers, a liquid crystal display, light emitting diode display, or a flat panel electroluminescent display.

Display 201 may be a liquid crystal display (LCD) commonly used in laptops, cell-phones, fax machines, etc. An LCD display uses organic fluids called liquid crystals, because liquid crystals possess two important properties. First, liquid crystals are transparent but can alter the orientation of polarized light passing through them. Second, the alignment of liquid crystal molecules and their polarization properties can be changed by applying an electric field. Liquid crystals are sandwiched between two glass plates, the outsides of which having been coated with polarizing filters and the inner plate is typically backlit via fluorescent light. Inside these glass plates is a matrix of electrodes. When an element of the matrix, called a pixel, experiences a voltage change, the polarization of the adjacent liquid crystal molecules change, which alters the light transmitted through the LCD pixel and hence seen by the user.

Display 201 could equally use light emitting diodes (LEDs) which are a semiconductor device that converts electrical energy into light. LEDs work on the principle of electroluminescence and are produce little heat for an amount of light output. Display 201 could be a flat panel electroluminescent display, where a thin phosphor layer is set between vertical and horizontal electrodes. These electrodes form an X-Y Cartesian coordinate system. When a vertical and a horizontal electrode are charged, the phosphor at their intersection emits light.

The display 201 is connected to a local computer 202 that is in communication with an antenna 203. The antenna 203 receives signals 129 transmitted from either the satellite 128 or the radio tower 127. The local computer 202 supports the communications software that acquires and stores the signals 129 received by the antenna 203. The local computer 202 also supports the software that operates the display 201.

FIG. 3 shows architecture menu 300. Architecture menu 300 comprises login system 302. If a prospective user is not yet registered, there is registration system 304. Once the user is registered, the user has access to purchase system 310, upload system 312, create ad system 314, and account system 316. In the event that a purchaser has not already produced an advertisement to show on a display 201, the purchaser can create an advertisement using the create ad system 314. The create ad system 314 is comprised of a photo-paint software system that produces animated and still drawings. The purchaser can access the account system 316 to examine the financial activity on their account. The purchaser can view how many billboards she has purchased and at what price. The purchaser can also update their contact information such as phone, fax, mailing address, and email address. The purchaser can also update their billing information or credit card information through the account system 316.

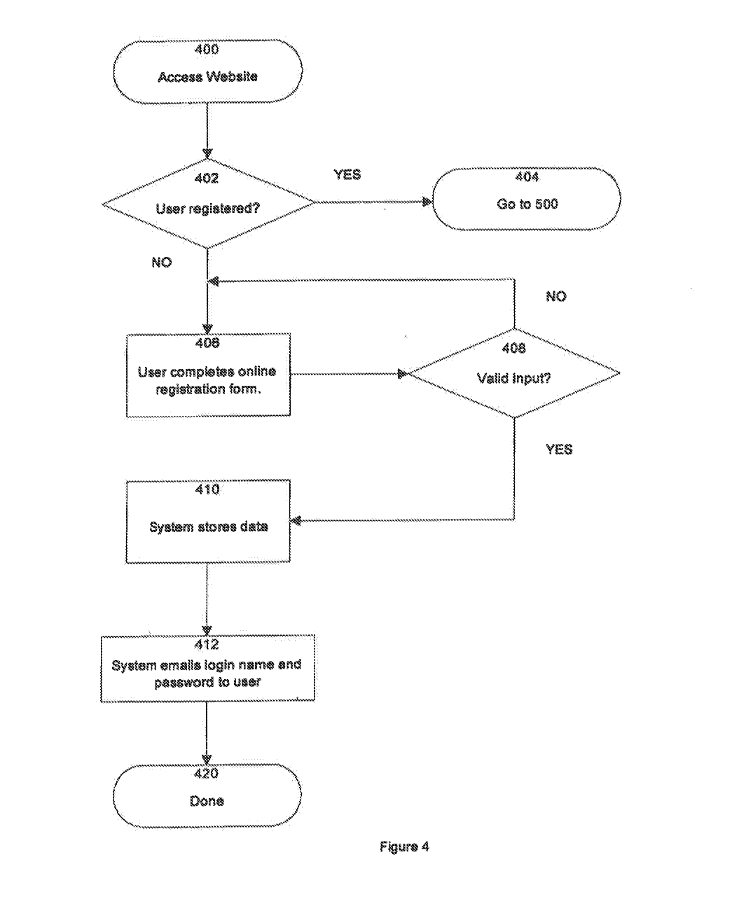

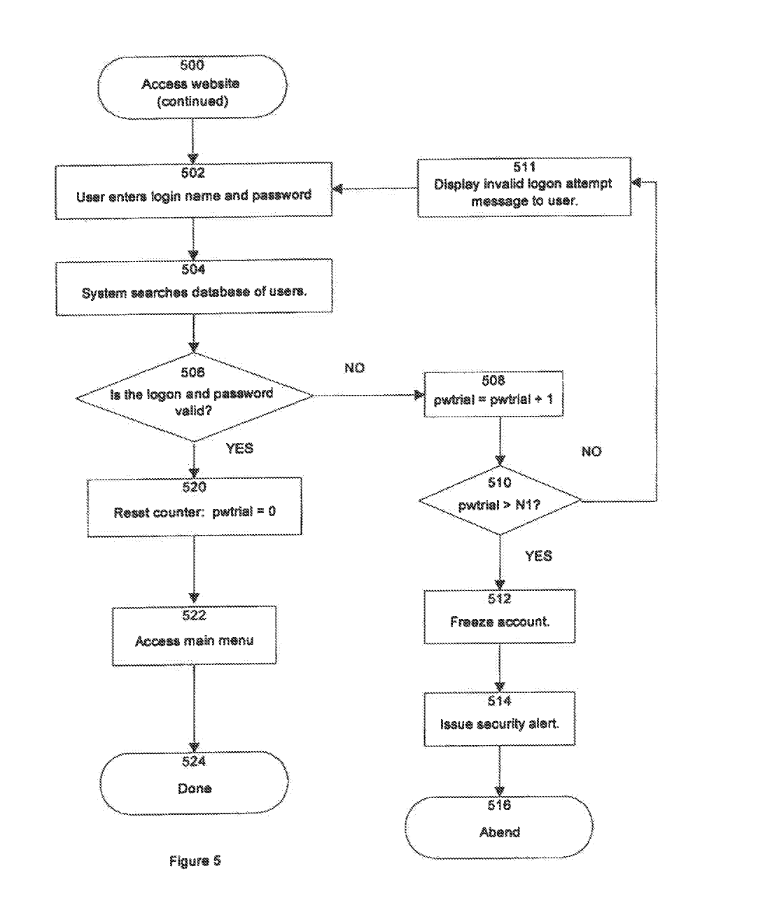

Registration system is further developed in FIG. 4. When a user accesses the website, step 400, step 402 is used to determine whether the user is already registered. If the user is already registered, the process flows to step 404, which sends the process to step 500 in FIG. 5.

However, if the user is not already registered in step 402, the registration process flows to step 406, where the user completes an online registration form. The registration process then flows to step 408, where the input provided by the prospective user is checked. If the input is not valid, due to invalid email address, nonexistent credit card information, etc., step 408 returns to step 406 and the user is again asked to complete the online registration form. However, if the input is verified as valid in step 408, the registration process flows to step 410 where the system stores the data for future use. Then the registration process flows to step 412, where the system entails a logon name and password to the user via the email address supplied by the user. Then the registration process ends at step 420.

In FIG. 5, the user enters his or her logon and password in step 502. In step 504, the system searches the database of users. From step 504, the logon process flows to step 506, where the system checks as to whether the logon and password are valid. If the logon and password are not valid, the logon process flows to step 508, where the counter of the number of logon attempts is incremented by one, pwtrial=pwtrial+1. In step 510, the counter pwtrial is compared against a threshold number N1. This threshold number could be set by the system administrator. A suitable value for N1 could be three. If the counter does not exceed this threshold number N1 in step 510, the logon process flows to step 511, where the user receives an “Invalid logon and password” message. Then, the process goes back to step 502 for another logon attempt.

However, if the counter of the number of logon attempts exceeds threshold N1 in step 510, the logon process flows to step 512 and the account is frozen for security reasons. This is to prevent hackers from causing harm. The logon process flows to step 514, where a security alert is issued to the system administrator before the logon process “abnormally ends” or abends in step 516.

If the user provides a valid logon and password in step 506, the logon process flows to step 520, where the counter of the number of logon attempts is reset to zero, pwtrial=0. Then the logon process flows to step 522 where the user is given access to the main menu, which was described in FIG. 3. The logon process flows to step 524, signifying that the logon process is now complete.

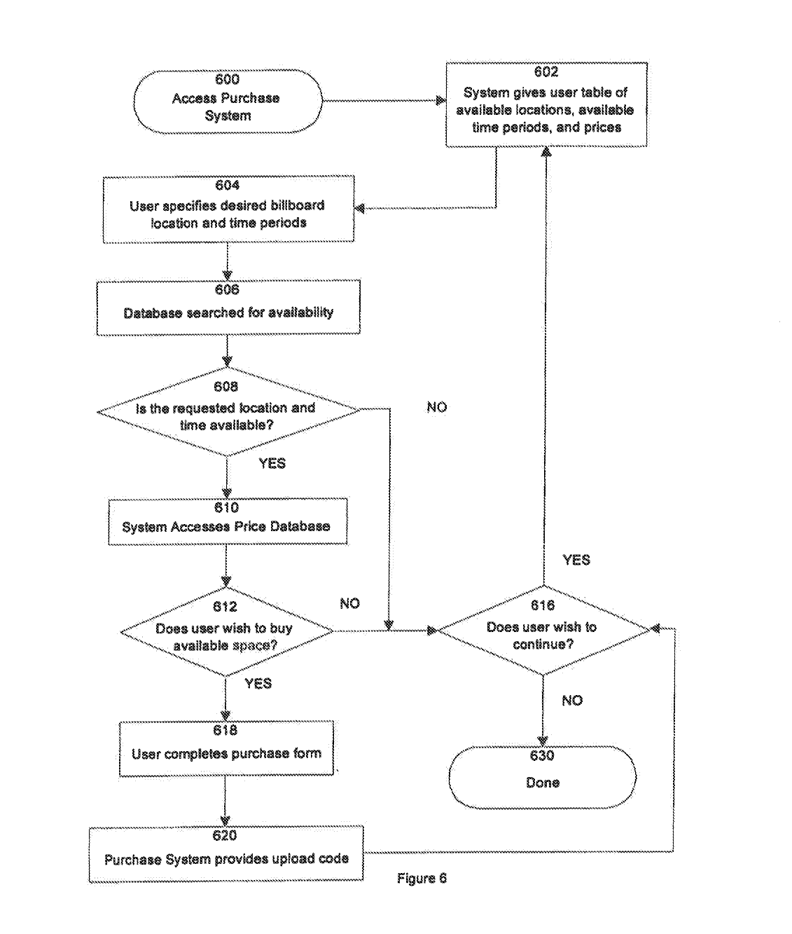

Once the logon process is completed, FIG. 5, the user may enter the access purchase system process, step 600 of FIG. 6. The purchase process flows to step 602, where the system gives the user a table of available locations, available time periods or slots, and the prices associated with those locations and time periods. The purchase process then flows to step 604, where the user specified the desired billboard location and time periods. The purchase process then flows to step 606, where the purchase process searches the database for the availability of the desired billboard location and time periods. In step 608, the query is made as to whether the requested location and time is available. If the requested location and time is not available, the purchase process flows to step 606, where the user is queried if he or she desires to continue with the purchase process. If the user does wish to continue with the purchase process in step 616, the process flows to step 602. If the user does not wish to continue with the purchase process in step 616, the purchase process exits at step 630.

If in step 608, the requested location and time is available, the purchase process flows to step 610, where the purchase process accesses the price database. Then the purchase process flows to step 612, where the user is asked whether he or she wishes to purchase the available location and time. If the user answers no, the purchase process flows to step 616. However, if the user does wish to purchase the location and time, the process flows to step 618 and the user then completes an online purchase form. The purchase process then flows to step 620, where the user is provided with an upload code, for uploading his or her advertisement. Then, the purchase process flows back to step 616, where the user is queried whether he or she wishes to continue and possibly make additional purchases.

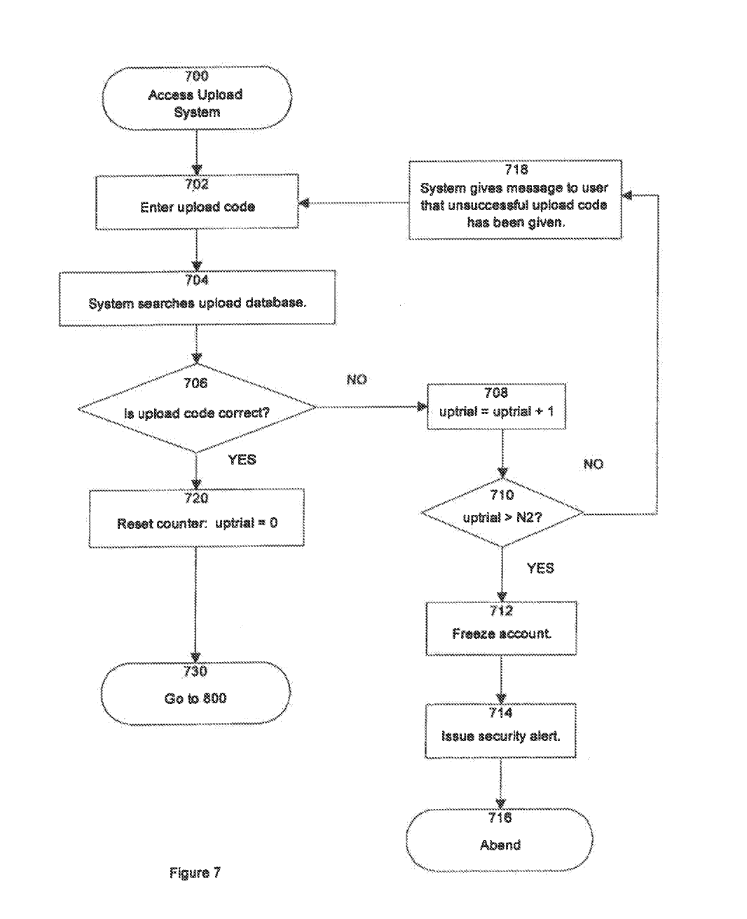

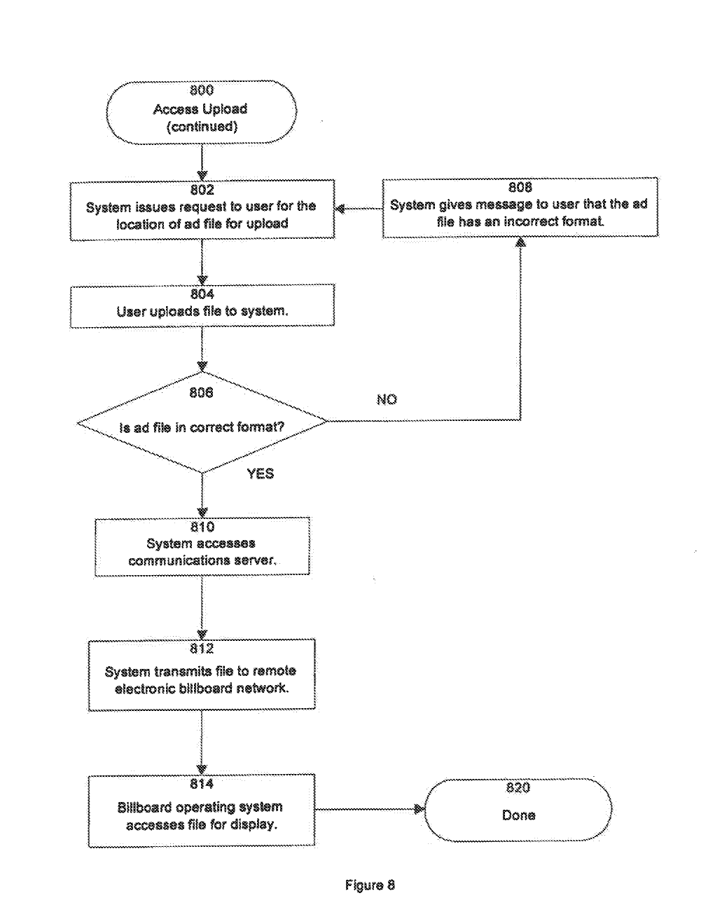

In FIG. 7, the user prepares to upload advertising in step 700. The upload process flows to step 702, where the user provides the upload code. The upload process flows to step 704, where the system searches the upload database in an attempt to check the validity of the upload code. If the upload code is correct, the upload process flows to step 720, where the counter for attempts to enter the upload code is reset to zero, uptrial=0. Then the upload process flows to step 730, which signifies a jump to step 800 of FIG. 8.

If the upload code is not correct in step 706, the logon process flows to step 708, where the counter of the number of upload code attempts is incremented by one, uptrial=uptrial+1. In step 710, the counter uptrial is compared against a threshold number N2. This threshold number could be set by the system administrator. A suitable value for N2 could be three. If the counter does not exceed this threshold number N2 in step 710, the logon process flows to step 718, where the user receives an “Invalid upload code” message. Then, the process goes back to step 702 for another logon attempt.

However, if the counter of the number of upload code attempts exceeds threshold N2 in step 710, the logon process flows to step 712 and the account is frozen for security reasons. This is to prevent hackers from causing harm. The logon process flows to step 714, where a security alert is issued to the system administrator before the logon process “abnormally ends” or abends in step 716.

FIG. 8 gives the rest of the upload process, which begins with step 800, which the user reaches upon correctly entering his or her upload code. The upload process then continues to step 802, where the system issues a request to the user for the location of the advertisement file for upload. The upload process flows to step 804, where the user provides the location of the file to be uploaded and the file is uploaded to the system. The upload process then flows to step 806, where the system performs a check of the advertisement file, to insure it is in the correct format and compatible with the display technology which will display the file. If the advertisement file is not correct in step 806, the upload process flows to step 808, where an “Improper Format” message is displayed to the user. Then the upload process flows from step 808 to step 802 where the user can upload a correct advertising file.

If the advertising file is in the correct format in step 806, the upload process flows to step 810, where the system accesses the communications server. The upload process then flows to step 812, where the system transmits the advertisement file to the remote electronic billboard network. Then upload process then flows to step 814, where the advertisement file is displayed on the electronic billboard at the desired location and desired time. The upload process then flows to step 820, which is the conclusion of the upload process.

FIG. 9 shows a user/registration database 900. Template 900 includes the contact person's name 901, mailing address 902, city 903, state 904, country and Zip code 905, phone number 906, fax number 907, email address 908, and company name 909, name of contact 910, username 911, password 912, and Internet address 913, A purchaser seeking to register as a user on the system will provide information for 901, 902, 903, 904, 905, 906, 907, 908, 909, 910, and 913. The registration system 304 generates the username 911 and the password 912 and stores them in the table 900. The registration system emails the username 911 and the password 912 to the purchaser at the email address 908.

FIG. 10 shows an electronic billboard database 1000. The table 1000 provides a listing of all of the electronic billboard systems 130 in the network by their billboard number 1001, street address 1010, city 1011, state 1012, and zip code 1013. The purchase system 310 uses the information 1001, 1010, 1011, 1012, and 1013 to generate a map showing the locations of billboards 130 available for purchase. Section 1014 provides a table of the times and prices of the billboards 130. The billboards in this table are shown being for sale in four hour blocks of time at 12 am, 4 am, 8 am, 12 pm, 4 pm, and 8 pm. An “X” in a time block indicates that the billboard 130 has already been purchased. A number in the time block indicates the price at which that four hour time block for that billboard 130 can be purchased. If the purchaser buys a block of time, the purchase system 314 writes an “X” in the table for every block of time purchased. While this table is shown dividing the available electronic billboard space into four hour blocks of time, any time increment is possible.

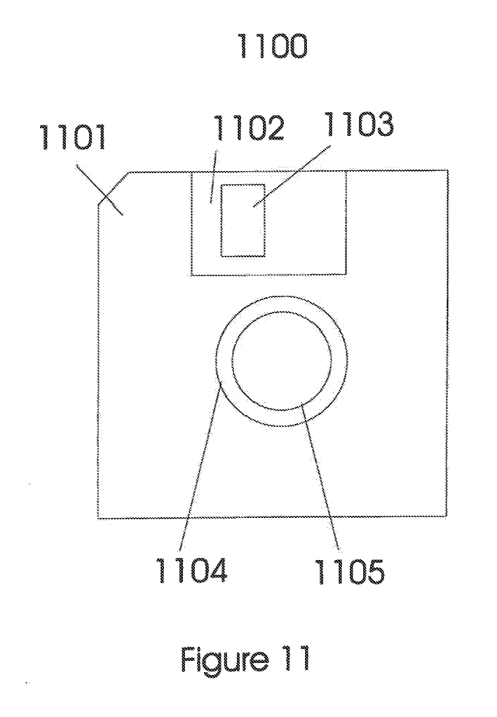

FIG. 11 shows a typical floppy disk cartridge 1100 which could be used hold the microcode used in processing the activity of the electronic billboard management system. Floppy disk cartridge 1100 consists of cartridge body 1101 and shutter 1102. Shutter 1102 has an opening 1103, so that I/O can be performed on the data on disk inside of the cartridge body 1101. Cartridge body 1101 has an opening 1104 so that the hub 1105 of the floppy disk can be rotated by a floppy disk drive, for the purposes of I/O.

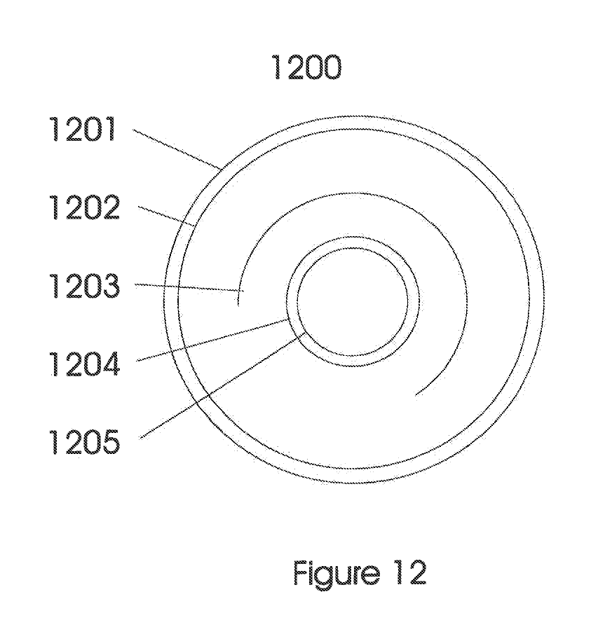

FIG. 12 shows a typical floppy disk 1200 which would be contained in floppy disk cartridge 1100. Floppy disk 1200 has an circular outer perimeter 1201. Data is recorded in circular or spiral tracks 1203 between the inner recording radius 1204 and the outer recording radius 1202. Hub 1205 is used to rotate the floppy disk 1200 so that I/O can be performed on the data in tracks 1203.

FIG. 4 shows computer chip 1300. Computer chip 1300 may be a RAM, EPROM, or ASIC chip, etc. The exterior of chip 1300 shows a typically square or rectangular body 1301 with a plurality of electrical connectors 1302 along the perimeter of body 1301. There is typically an alignment dot 1303 at one corner of chip 1300 to assist with the proper alignment of chip 1300 on a card. Within body 1301, chip 1300 consists of a number of interconnected electrical elements, such as transistors, resistors, and diodes. These interconnected electrical elements are fabricated on a single chip of silicon crystal or other semiconductor material such as gallium arsenide (GaAs) by use of photolithography. One complete layering-sequence in the photolithography process is to deposit a layer of material on the chip, coat it with photoresist, etch away the photoresist where the deposited material is not desired, remove the undesirable deposited material which is no longer protected by the photoresist, and then remove the photoresist where the deposited material is desired. By many such photolithography layering-sequences, very-large-scale integration (VLSI) can result in tens of thousands of electrical elements on a single chip. Ultra-large-scale integration (ULSI) can result in a hundred thousand electrical elements on a single chip.

While the invention has been shown and described with reference to a particular embodiment thereof, it will be understood to those skilled in the art, that various changes in form and details may be made therein without departing from the spirit and scope of the invention.

1.-9. (canceled)

10. An apparatus for a wireless electronic billboard commerce system comprised of:
a plurality of electronic billboards wherein each electronic billboard comprises:
a video display for showing a video stream;
a billboard computer adapted to process digital files to show on said video display as a video stream, said billboard computer is coupled to and controls said video display; and
a billboard antenna coupled to said billboard computer for transferring video data to said billboard computer;
a local Ethernet coupled to a global computer network, wherein said local Ethernet comprises:
a main computer to manage said local Ethernet;
a communication system to wirelessly communicate with the plurality of electronic billboards, wherein the communication system comprises:
a communication server coupled to the main computer system for storing data to transmit; and
a transmission antenna coupled to said communication server to transmit the data and receive transmitted data;
a web server coupled to the main computer for hosting a website accessible from the global computer network;
a database server coupled to the main computer, the database server comprising:
a registration system to allow a party to become a registered user of said wireless electronic billboard commerce system;
login system coupled to the registration system to allow registered users access to said wireless electronic billboard commerce system, wherein the login system will send a security alert to the main computer when a login 10 and password are invalid multiple times within a predefined time frame to freeze an associated account;
an account system coupled to said login system to allow the registered user to view and update financial activity, billboard purchases, contact information, and billing information;
an ad creation system coupled to the login system for allowing said register user to create new video advertisements within said wireless electronic billboard commerce system to display on at least one of said plurality of electronic billboards;
an access purchase system that provides a table of billboard information, said table of billboard information includes a listing of available locations, a listing of available time periods, and a listing of prices, said access purchase system searches a database to determine if said electronic billboard is available to display said advertisement at a requested location and a requested time; and
a video advertisement stored as a digital file in the database server, said digital file is uploaded to said main computer through said global computer network, said main computer transfers said digital file to said communication system, said communication system transmits said digital file as a signal, said billboard antenna receives said signal, said billboard computer processes said signal, said billboard computer shows said signal on said video display as a video stream.

11. The apparatus described in claim 10, further comprising a satellite, said satellite receives said digital file from said communication server and transmits said digital file to said billboard antenna.

12. The apparatus described in claim 10, wherein said display is a flat panel electroluminescent display.

13. The apparatus described in claim 10, wherein said display is a liquid crystal display.

14. The apparatus described in claim 10, wherein said display is a light emitting diode display.

15. The apparatus described in claim 10, further comprising a web-site, said web-site is contained on said main computer, said web-site is accessible on said global computer network.

16. The apparatus described in claim 10, further comprising an upload database, said access purchase system provides an upload code for said digital file when said advertisement is purchased, said main computer accesses said upload database to determine if said upload code is acceptable, said main computer transfers said digital file to said communications system when said upload code is verified.
